(19) United States
(12) Patent Application Publication
(10) Pub. No.: US 2008/0147378 A1
(43) Pub. Date: Jun. 19, 2008

(54) Online computer-aided translation

(76) Inventor: Patrick J. Hall, Silver Spring, MD (US)

Correspondence Address: FISH & RICHARDSON P.C., PO BOX 1022, MINNEAPOLIS, MN, 55440-1022, US

(21) Appl. No.: 11/953,802

(22) Filed: Dec. 10, 2007

Related U.S. Application Data
(60) Provisional application No. 60/873,812, filed on Dec. 8, 2006.

(51) Int. Cl. G06F 17/28

(52) U.S. Cl. 704/4

(57) ABSTRACT

A source text in a source language is received. The source text is segmented into a plurality of segments. A first translation input, in a target language and associated with a first one of the segments, is received from a user. The first translation input is stored in a textual data repository.

### RELATED APPLICATIONS

This application claims the benefit under 35 U.S.C. § 119 of U.S. Provisional Application No. 60/873,812, titled “Online Computer-Aided Translation,” filed Dec. 8, 2006, which is incorporated by reference herein in its entirety.

### BACKGROUND

This disclosure relates generally to computer-aided translation.

As the World Wide Web has grown and has become an international medium, the dominance of English as the language of choice for content on the Web has waned as well. Much content on the Web are written in languages other than English. An example of this phenomenon takes place in the blogosphere, where there are many blogs written in languages other than English. This growth in non-English blogs, and in non-English Web content generally, increases the need for language translation to bridge the gap between languages.

An option for translation is machine translation, where content is translated entirely by a computer. However, machine translation has its limitations, such as issues with accuracy and the limited number of language pairs that can be handled by machine translation. Another option for translating content is computer-aided translation (CAT), where humans, with assistance from software programs, translate content. However, the CAT software currently available tends to be expensive and marketed to professionals. This can drive up the cost of CAT and make such services inaccessible to many people or groups.

### SUMMARY

In general, one aspect of the subject matter described in this specification can be embodied in methods that include the actions of receiving a source text in a source language; segmenting the source text into a plurality of segments; receiving from a user a first translation input in a target language, the first translation input being associated with a first one of the segments; and storing the first translation input in a textual data repository. Other embodiments of this aspect include corresponding systems, apparatus, computer program products, and computer readable media.

In general, another aspect of the subject matter described in this specification can be embodied in a system that includes a translation matcher for matching translators with requests for translation of content, a translation editor for facilitating translation of content, and a translation database for storing translations of content. Other embodiments of this aspect include corresponding systems, apparatus, methods, computer program products, and computer readable media.

Particular embodiments of the subject matter described in this specification can be implemented to realize one or more of the following advantages. The source text and the work product for a translation project can be accessible from a computer with a web browser, without installing specialized software or add-ons. A client commissioning a translation project can check on the progress of the project on their own. A translator can collaborate with and seek assistance from other translators.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example aggregator interface.

FIG. 2 shows an example editor interface.

FIG. 3 shows an example entity relationship diagram for an online computer-aided translation service.

FIG. 4 shows an example process for requesting a translation.

FIG. 5 shows an example process for accepting a translation request.

FIG. 6 illustrates an example process for receiving and storing a translation input.

FIG. 7 illustrates an example system for receiving and storing source texts and translations.

Like reference numbers and designations in the various drawings indicate like elements.

### DETAILED DESCRIPTION

A computer-aided translation (CAT) tool may be implemented online. In some implementations, the CAT tool is a Web-based service hosted at a website. Through the CAT website, a translator may select content to translate, enter a translation for the selected content, and get the translated content published.

In some implementations, an online CAT tool includes an aggregator for managing source content and selecting content to translate, an editor to help the translator work quickly and efficiently, and an outbox for organizing completed translations into outgoing content.

A translator who wishes to translate content may register for an account with the CAT tool. The CAT tool may include pages for account management and setting personal preferences.

In some implementations, the CAT tool is implemented as web pages using Hypertext Markup Language (HTML), JavaScript, Extensible Markup Language (XML), Asynchronous JavaScript and XML (AJAX), and other suitable technologies. The web pages can be rendered in web browsers.

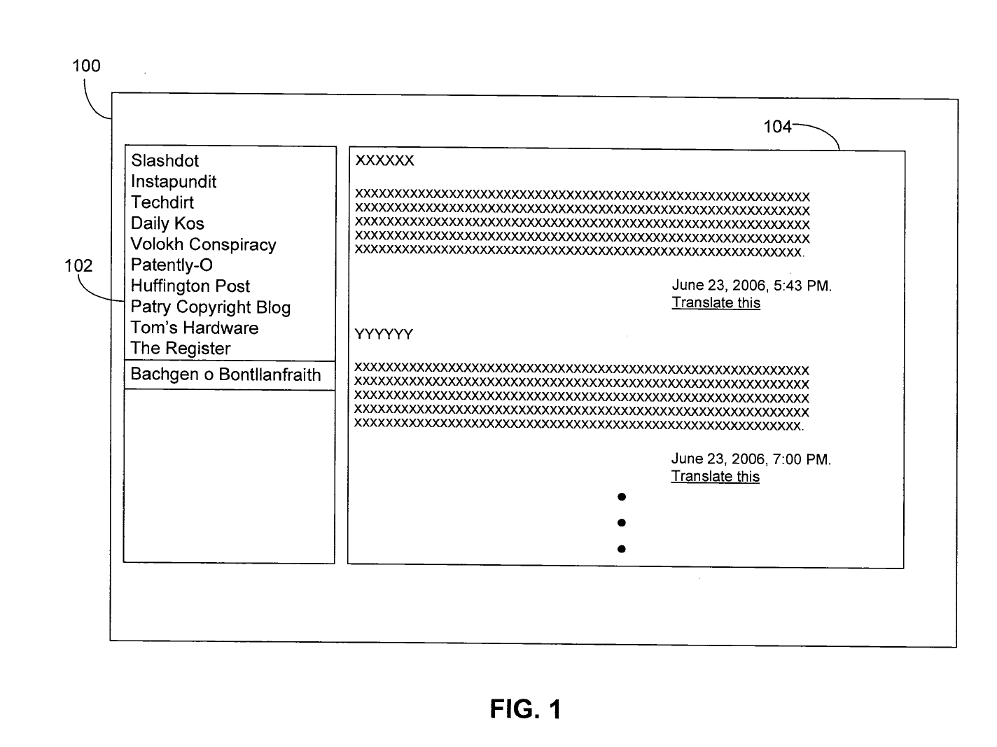

FIG. 1 shows an example aggregator interface. The aggregator facilitates selection of content for translation (“source content”) by a translator. The aggregator presents source content (e.g., blogs, webpages) that is available for translation. In some implementations, the layout of the aggregator includes an area 102 for displaying a list of source content available for translation, such as titles of blogs, webpages, and so forth, and another area 104 for displaying the content under the currently selected title. In some implementations, the displayed content may include a link or some other user interface object, which may be labeled as “Translate this.” The translator may select the link or the object to accept the content for translation. In some implementations, the user interface is taken to an editor, where the translator conducts the translation, further details of which are described below. In some other implementations, the content is added to the translator's translation docket.

The aggregator may include tools for adding content to the aggregator. In some implementations, there is a user interface for adding a blog to the aggregator by specifying the Universal Resource Locator (URL) of the blog or its content feed (e.g., RSS feed, Atom feed). When the translator submits the blog URL, the content of the blog is retrieved (e.g., by accessing its content feed), and the content is added to a database. The translator can then browser the added content and select any for translation. In some implementations, a similar user interface may be used to add other content, such as web pages, for translation. In some other implementations, content may also be added without intervention by the translator. For example, the aggregator may show requests for translation from others, and the translator may browse the requests and select ones they wish to accept. As another example, the CAT tool may automatically assign a translator content based on any number of criteria, such as the languages involved and the skill set of the translator.

In some implementations, the aggregator may present the translator with content available for translation, where the content may be organized by source (e.g., blog, website domain, requester of translation, etc.) and presented in particular units, such as blog posts, individual web pages, etc. The translator may pick particular units of content to add to their translation docket. For example, the translator may add a blog to the aggregator. The aggregator presents the translator with the posts from the blog, and the translator may select particular posts of the blog for addition to their docket.

In some implementations, source content are stored at a server or a plurality of servers. For example, source content can be extracted from blogs, websites, etc. and stored at the server. As another example, files of source content can be uploaded to the server. As a further example, source content text can be entered into a form (e.g., by typing, copying and pasting, etc.) and the text is sent to the server for storage. The source content is stored in a repository of textual data (e.g., a database) at the server. The aggregator interface can display source content stored in the textual data repository to potential translators for selection. In some implementations, the source content text is partitioned into segments at the server. The segments can be sentences, paragraphs, cells of a table, etc.

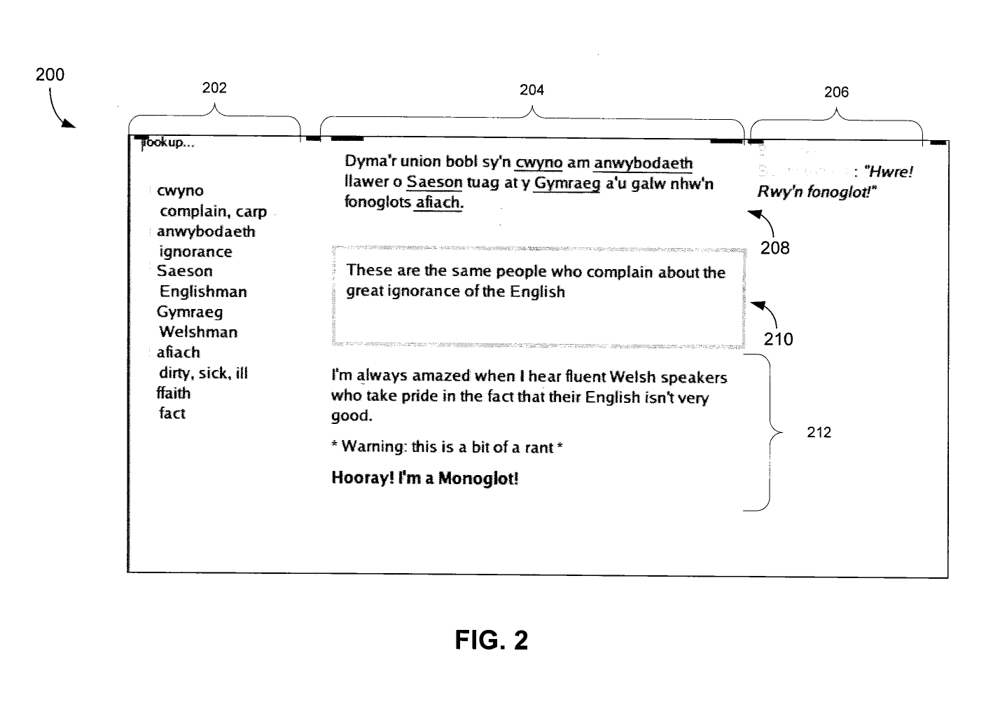

FIG. 2 shows an example editor interface. The translator may conduct the translation of source content in the editor 200. In one implementation, the editor includes a glossary 202, an editing area 204, and an area 206 for displaying miscellaneous information. In some implementations, the editor automatically partitions or segments the source content to be translated into smaller units (“segments”). In some implementations, the segments are individual sentences, demarcated by sentence-ending punctuation such as periods, question marks, etc. In some other implementations, the segments are paragraphs in the source content text, cells of a table, or the like.

In FIG. 2, the editing area 204 is showing segments of a blog post written in Welsh, along with any translations for the segments that have been entered. The current segment being translated (the text beginning with “Dyma'r union bobl . . . ”) is shown in a current sentence area 208. The translator may type in the translation for the segment shown in the current segment area 208 in the current segment translation area 210. Completed translations of segments may be displayed in completed translations area 212. In some implementations, the completed translations are displayed in reverse order of completion; as the translator completes each individual segment and submits the translation (e.g., by pressing the “Enter” key, pressing a “Submit” button, etc.), that segment is pushed onto the top of the list of sentences in the completed translations area 212. For instance, when the translation for the current sentence, “These are the same people . . . ” is completed, it will take its place above the sentence below it that begins “I'm always amazed . . . .” The text flows from the top to the bottom, similar to blogs, except that instead of individual posts the units of content here are sentences. In some implementations, the translation of a segment is displayed when the segment is highlighted or selected for editing. In some implementations, the original source content text and the translations can be displayed in a side-by-side view.

The underlined words in the current sentence being translated are those words that have been found in the glossary of the CAT tool, and they may be displayed in the glossary area 202.

In some implementations, the translation of a segment is saved to a server when the translation of the segment is submitted by the translator, as opposed to saving when the translation for the entire source content is completed. For example, the translation can be stored in the textual data repository where the source content is stored. Thus, translations can be saved segment by segment as the translator proceeds with the translation of the source content text. Within the textual data repository, the translation can be associated with the corresponding segment of source content.

The textual data repository, with the source content texts and the translations of segments of the source content text, can be searchable. For example, the editor interface 200 can include a search box for searching the textual data repository for segments of source content text. A user (e.g., a translator) can enter into the search box a text query, and the textual data repository is searched for segments that include the text query. The matching segments and their translations are returned as search results to the user. Thus, translators can search for text in the textual data repository to see how other translators have translated the text.

In some implementations, a translation completion percentage or rate for a source content text can be calculated based on the number of segments (or the number of words/characters in the segments) of the source content that have translations saved in the textual data repository and the total number of segments (or the total number of words/characters) in the source content text. The completion percentage can be displayed in the editor interface 200 with the source content text. The completion percentage can also be displayed to a client who commissioned the translation (e.g., when the client is accessing the source content text and the translation to gauge progress of the translation.

In some implementations, source content and translations in the textual data repository are open to viewing to translators and clients without restriction. However, it may the case that a source content text and the translation of the source content text includes confidential information or other information that the client commissioning the translation does not want to disclose to unauthorized parties. In some implementations, searching, and viewing, and editing of the source content text and the translation can be restricted to the client and authorized parties (e.g., translators commissioned to perform the translation). The restriction can be for the entire piece of source content text or on a segment by segment basis (e.g., some segments are open to the public and other segments are restricted to authorized parties).

In some implementations, a comment thread can be generated and associated with a segment of source content text. A user (e.g., the translator translating the segment) can request assistance from other translators using the comment thread. Thus, the comment thread can facilitate collaboration in translation. Further, in some implementations, the number of quality comments by a translator (e.g., comments where a translator provided assistance that was voted by other users as being helpful) can be used to determine a quality or reputation metric of a translator.

As described above, the textual data repository can be stored at one or more servers. The content of the textual data repository (i.e., the source content and the translations) can be accessed by users (e.g., translators, clients) through a Web-based interface (e.g., the aggregator interface 100 and editor interface 200).

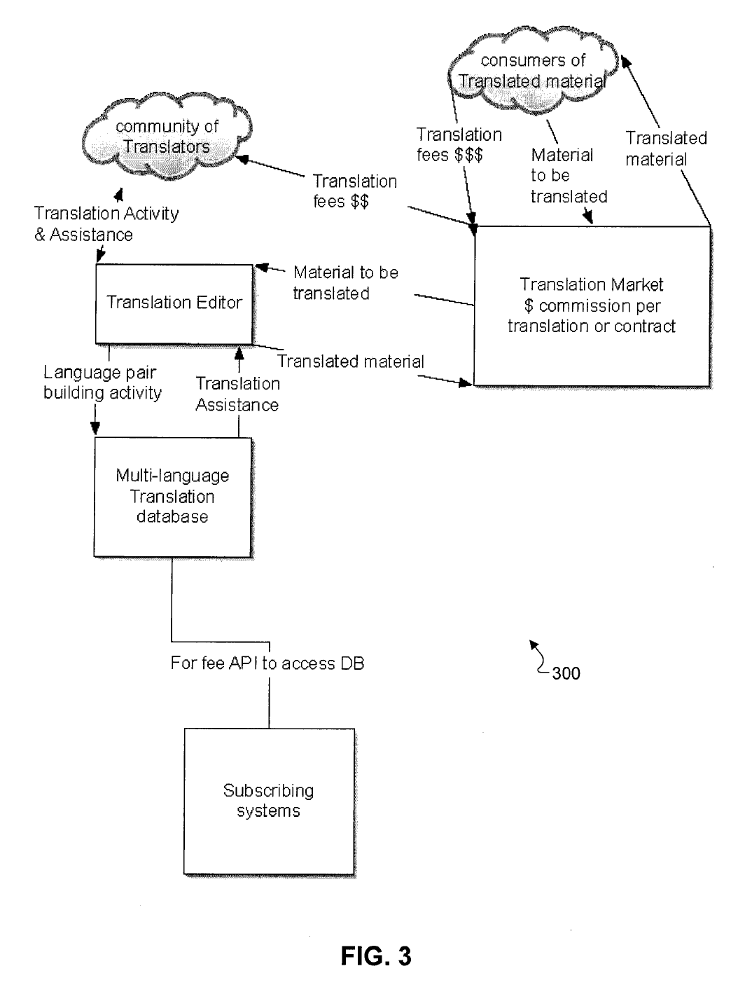

FIG. 3 shows an example entity relationship diagram 300 for an online computer-aided translation service. In some implementations, the diagram 300 also represents a system for online computer-aided translation. There are consumers of translated material who wish to have material or content translated. These consumers may participate in a translation market. In the translation market, the consumers may place translation requests and specify or provide the material to be translated. The consumers also pay a translation fee at a predefined rate or specify how much they are willing to pay for a translation (i.e., place a bid). A community of translators may review the translation requests and decide which requests to accept. Translators may also be matched with requests based on any number of criteria, such as skill set, languages involved, and the bid for the request. The translators may also specify their price rates.

When a translator is ready to translate an item of content, the translator may use a translation editor to conduct the translation. The translated content is returned to the corresponding consumer. At least a portion of the amount of the translation fee paid by the consumer may be paid to the translator. The translation market may also get a portion of the fee paid by the consumer as a commission, service charge, or the like.

The translated content is also saved in a database of translations. The database may store original materials and their translations for any number of language pairs. In some implementations the translation database is the textual data repository described above. The translations in the database may be accessed by translators to assist them in performing their translations. In other words, translated content is saved and may be used as samples or references by translators in the future.

In some implementations, translators may also rate the translation of other translators. Such ratings may be saved in the database. From these ratings, translators may build a reputation within the community of translators and in the translation market. The reputation may be reflected in a rating and may be provided to consumers requesting translations.

The translation database may be viewed as a corpus of content and translations of the content. In some implementations, an application programming interface (API) may be provided to entities or systems who wish to access the corpus. For example, a machine translation system may access the corpus to train its translation algorithms. The API may be provided for free or as a paid subscription or license.

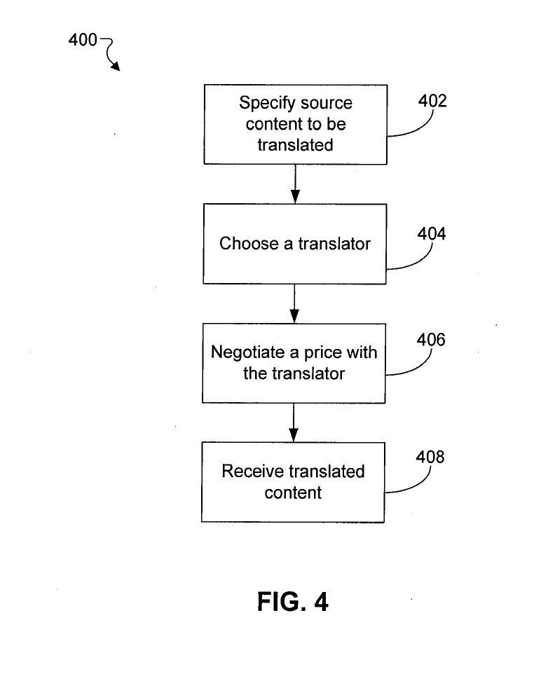

FIG. 4 shows an example process 400 for requesting a translation. A consumer specifies the content to be translated (402). In some implementations, the consumer specifies the source language of the content, the target language of the content, and the source format (e.g., whether the content is a webpage indicated by URL, a content feed indicated by a URL of the feed, an email, etc.). The consumer may also specify other information, such as a due date and a bid for the fee.

The consumer chooses a translator (404). In some implementations, the consumer may request a particular translator by name. The consumer may also search for a translator by any number of criteria, such as languages, translator ratings, and special skills (e.g., skill in legal texts, skill in medical texts, skill in texts on aviation, etc.).

The consumer and the translator negotiate a price (406). Both the consumer and the translator may bid until a mutually agreeable price is reached. In some implementations, the price may be expressed in terms of cost per word or cost per character.

In some implementations, the price negotiation is omitted. The translators may specify their rates in advance and consumers may select a translator based on price, among other factors. The consumers may reject translators whose rates are not agreeable.

After the selected translator translates the content, the consumer receives the translated content (408)

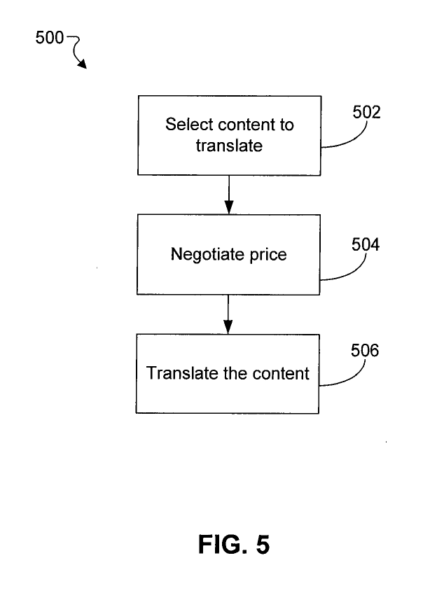

FIG. 5 shows an example process 500 for accepting a translation request. A translator may select a translation request for acceptance (502). Various criteria may be used to sort the requests, so that the translator can find the requests they prefer more efficiently. Non-exhaustive examples of sorting criteria include language, special skill required, price, amount of content to be translated, and due date. In some implementations, the translator may review the original content of a request before deciding whether to accept a request.

After the translator accepts a request, the translator and the requesting consumer may negotiate a price (504). After a price is agreed upon, the translator proceeds to translate the content (506). The translator may use the editor 200 described above and related tools to conduct the translation. After the translation is complete, the translation is delivered to the consumer.

In some other implementations, translators may specify their skill set and rate in advance, and consumers may place requests that specify the languages involved, any required skills, and a price. Translators may be automatically matched with the requests (or requests assigned to translators) based on the specified information.

In further other implementations, the translators may perform translation services for free.

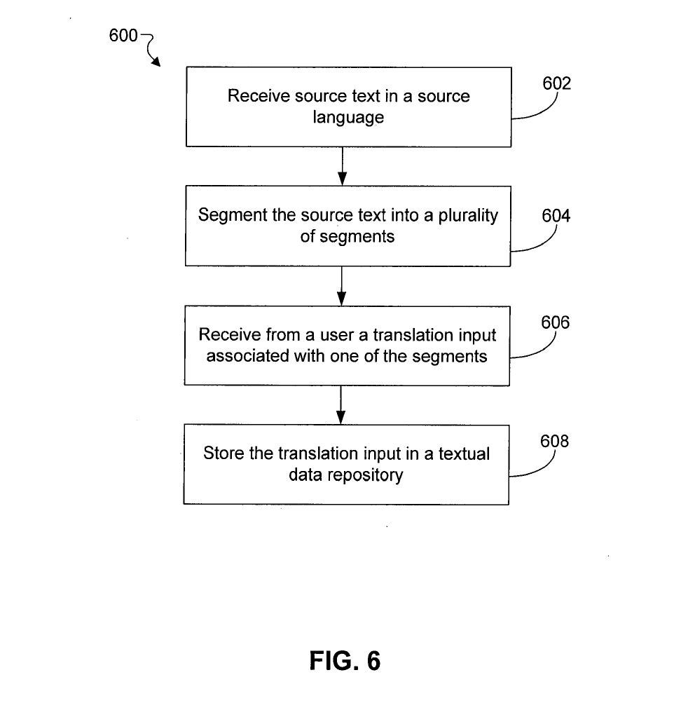

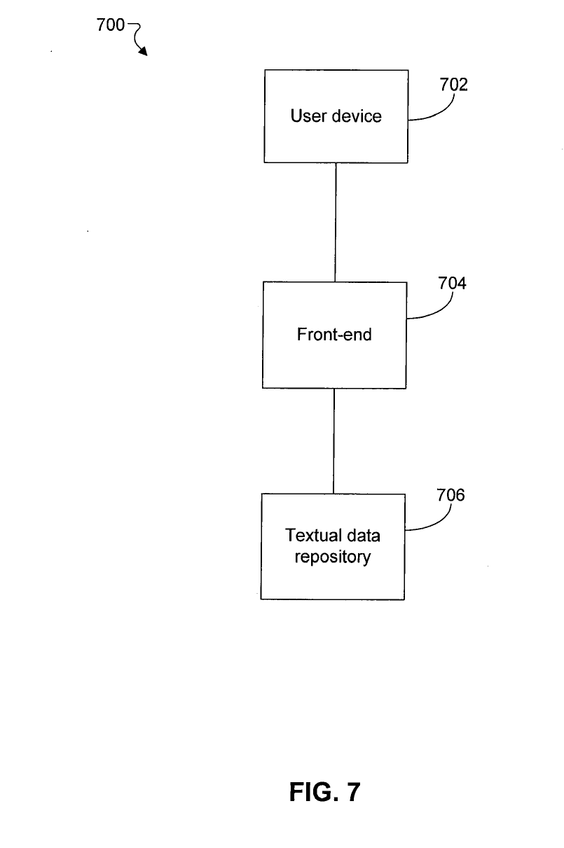

FIG. 6 illustrates an example process 600 for receiving and storing a translation input. A source text in a source language is received (602). A client who wishes to commission a translation project can submit the source text to a system (e.g., system 700, FIG. 7) in a file or as an input into a form, for example. In some implementations, the file or form input is received by a front-end 704 (FIG. 7) and stored in a textual data repository 706 (FIG. 7).

In some implementations, a Universal Resource Locator (URL) is provided by the client, and the system 700 (e.g., front end 704) can retrieve the source text from the provided URL.

The source text is segmented into a plurality of segments (604). In some implementations, the segments are individual sentences of the source text; each sentence in the source text is a segment. In some other implementations, the segments are paragraphs of the source text. Other units of segmentation are possible. A source text can be its own segment if it is short enough to be within one segmentation unit. For example, a source text that just one sentence has one segment: the sentence itself (assuming that the sentence is the unit of segmentation). In some implementations, the source text is stored in the textual data repository 706 in the form of its segments. When the source text is displayed to a translator in the editor interface 200, the source text is displayed as segments.

A translation input for one of the segments is received from a user (606). A user (e.g., a translator) can enter, in the editor interface 200, translations into a target language for any number of the segments of the source text. The translator enters the translations segment by segment. The translator submits the translation input for a segment through the editor interface 200 and the system 700 receives the input.

The translation input is stored in the textual data repository (608). The received translation input is stored in the textual data repository without necessarily waiting for completion of translation of the entire source text.

The translator can enter translations for the other segments. The system 700 receives the translation inputs and stores them into the textual data repository on a per-segment basis.

FIG. 7 illustrates an example system for receiving and storing source texts and translations. System 700 includes a front-end 704 and a textual data repository 706. In some implementations, the front-end 704 is a web server. In some implementations, the front-end 704 serves Web-based interfaces for facilitating computer-aided translation, including aggregation interface 100 and/or editing interface 200, for example. The Web-based interfaces can be accessed by users (e.g., translators, clients) from a user device 702 that can render and display Web pages (e.g., user device with a web browser application). Examples of user devices 702 include desktop computers, notebook computers, smartphones, mobile phones, personal digital assistants (PDAs), tablet computers, and so on.

Textual data repository 706 stores source text and corresponding translations. In some implementations, source texts are stored in the textual data repository as segments and the stored translations are respective translations for the segments. In some implementations, the textual data repository 706 serves the role of the translation database described above in reference to FIG. 3. In some implementations, the textual data repository 706 can be stored in a computer (e.g., a server) or stored or distributed over multiple computers (e.g., servers).

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method, comprising:
receiving a source text in a source language;
segmenting the source text into a plurality of segments;
receiving from a user a first translation input in a target language, the first translation input being associated with a first one of the segments; and
storing the first translation input in a textual data repository.

2. The method of claim 1, wherein the textual data repository is stored in one or more servers.

3. The method of claim 1, further comprising:
receiving from the user a second translation input in a target language, the second translation input being associated with a second one of the segments; and
storing the second translation input in the textual data repository.

4. The method of claim 1, further comprising:
receiving a query in a first language;
searching the textual data repository for one or more text strings in the first language that match the query, wherein the textual data repository includes a respective translation in a second language associated with each of the matching text strings in the first language; and
presenting the translations in the second language.

5. The method of claim 1, further comprising:
storing the source text in the textual data repository.

6. The method of claim 1, further comprising:
generating a comment thread for a respective segment.

7. The method of claim 1, wherein one or more of the segments of the source text are associated with respective translation inputs from the user in the second language, the segments of the source text and the respective translation inputs being stored in the textual data repository, the method further comprising:
determining a translation completion rate for the source text based on a quantity of the translation inputs and a quantity of the source text; and
presenting the translation completion rate.

8. A computer program product, encoded on a tangible program carrier, operable to cause a data processing apparatus to perform operations comprising:
receiving a source text in a source language;
segmenting the source text into a plurality of segments;
receiving from a user a first translation input in a target language, the first translation input being associated with a first one of the segments; and
storing the first translation input in a textual data repository.

9. A system, comprising:
one or more servers operable to store a textual data repository; and
a computer operable to:
receive a source text in a source language;
segment the source text into a plurality of segments;
receive from a user a first translation input in a target language, the first translation input being associated with a first one of the segments; and
store the first translation input in the textual data repository.

10. A system, comprising:
a translation matcher for matching translators with requests for translation of content;
a translation editor for facilitating translation of content; and
a translation database for storing translations of content.
